(19) United States
(12) Patent Application Publication
(10) Pub. No.: US 2024/0269895 A1
(43) Pub. Date: Aug. 15, 2024

(54) MATERIAL CONVEYING DEVICE

(71) Applicant: ACH Solution GmbH, Fischlham (AT)

(72) Inventor: Christian Hefner, Fischlham (AT)

(21) Appl. No.: 18/418,561

(22) Filed: Jan. 22, 2024

(30) Foreign Application Priority Data
Jan. 26, 2023 (AT) A 50039/2023

(51) Int. Cl. B29B 7/42; B29C 45/18; B29C 45/77; B29C 48/285; B29C 48/29; B29C 48/92

(52) U.S. Cl. CPC B29B 7/42; B29C 45/1808; B29C 45/77; B29C 48/286; B29C 48/29; B29C 48/92; B29C 2045/1875; B29C 2945/76525; B29C 2945/76545; B29C 2945/76605; B29C 2945/76615; B29C 2948/9258; B29C 2948/926; B29C 2948/92676; B29C 2948/92733

(57) ABSTRACT

The invention relates to a material conveying device for feeding at least one injection molding and/or extrusion unit with a non-free-flowing or viscous feed material, having a feed hopper rotatable relative to a bracket about an axis of rotation and a screw conveyor arranged rotatably along an inner jacket surface of the feed hopper in a screw shaft of the bracket, which is designed to convey the feed material from the feed hopper to an outlet, wherein the screw shaft is connected to a hopper outlet of the feed hopper, and wherein the screw conveyor is drivable via at least one drive device.

In order to enable the conveying of feed materials with different properties in the simplest possible way, it is provided that at least one media feed channel opens into the screw shaft, which is designed to feed at least one additional medium to the feed material, wherein at least one mixing device is arranged in the region of the screw conveyor and/or downstream of the screw conveyor, which is designed to mix the feed material and the additional medium.

The invention relates to a material conveying device for feeding at least one injection-molding and/or extrusion unit with a non-free-flowing or viscous feed material, having a feed hopper rotatable relative to a bracket about an axis of rotation and a screw conveyor arranged rotatably along an inner jacket surface of the feed hopper in a screw shaft of the bracket, which is designed to convey the feed material from the feed hopper to an outlet, wherein the screw shaft is connected to a hopper outlet of the feed hopper, and wherein the screw conveyor—preferably also the feed hopper—is/are drivable via at least one drive device. Furthermore, the invention relates to a method for feeding at least one injection-molding and/or extrusion unit with a non-free-flowing or viscous material, having a material conveying device with a—in particular rotatable—feed hopper with a screw conveyor which is rotatable about a rotation axis and which is arranged along an inner jacket surface of the feed hopper and which is rotatably mounted, wherein the screw conveyor—in particular also the feed hopper—is/are driven via at least one drive device.

Material conveying devices of the aforementioned type, each with a rotating conical feed hopper and a screw conveyor rotatably mounted along a generatrix, are known from the publications EP 0 286 972 A2, EP 0 470 510 A2, EP 0 687 543 A2, EP 1 317 009 A2, DE 10 2019 115 122 A1 and WO 2014/198 503 A1.

U.S. Pat. No. 5,662,415 A discloses a material conveying device for processing and degassing a material mixture for manufacturing products with solid surfaces. The material conveying device has a screw conveyor which is conically shaped in an initial region. An inlet, which starts from a material source, for example a mixer, opens into this conical area of the screw conveyor. A material outlet is located at the end of the screw conveyor. A catalyst material can be fed into the cylindrical end section of the screw conveyor via an inlet. A feed hopper that can rotate about an axis is not provided.

If products with different material properties, such as color, toughness, elasticity, etc., are to be manufactured, it was previously necessary to procure, store and process different feed materials for different material properties, which had a negative impact on the logistical effort and manufacturing costs.

The object of the invention is to avoid these disadvantages and to enable the conveying of materials with different properties in a simple manner.

According to the invention, this is achieved in a material conveying device of the aforementioned type in that at least one media feed channel opens into the screw shaft, which is designed to feed at least one additional medium to the feed material, wherein at least one mixing device is arranged in the region of the screw conveyor and/or downstream of the screw conveyor, which is designed to mix the feed material and the additional medium.

Preferably, the mouth of the media feed channel into the screw shaft is arranged between the hopper outlet and an end of the screw conveyor facing the outlet.

At least one liquid, pasty or free-flowing medium, for example a cross-linking agent, a silicone oil and/or paint material—in particular at least one paint paste—can be actively fed to the non-free-flowing or viscous feed material via the media feed channel. It is possible in this case to feed several media simultaneously or alternately, wherein a separate media feed channel can preferably be provided for each medium. For example, a silicone oil can be supplied via a media supply channel and a coloring material can be supplied via another media supply channel.

The mixing device is used to achieve good mixing of the feed material with the supplied medium.

In order to achieve a homogeneous composition of the feed material, it is advantageous if the mixing device is arranged in the screw shaft—preferably in the area of the end of the screw conveyor.

One embodiment variant of the invention provides that the mixing device comprises at least one, in particular circular, mixing disk, wherein the mixing disk preferably has at least one recess on the circumference and/or at least one bore. Tests have shown that good mixing is made possible in this way. The size of the recesses and holes can be advantageously designed to suit the viscosity of the material being conveyed and the medium being fed.

According to a further development of the invention, the mixing device has at least two axially spaced-apart mixing disks, wherein a screw-shaped mixing element is arranged between the two mixing disks.

Good mixing can be achieved if at least one mixing disk of the mixing device is non-rotatably connected to the screw conveyor. Alternatively or additionally, it may be provided that at least one mixing disk of the mixing device is floatingly connected to the screw conveyor. In this context, floating means that the mixing disk is loosely or rotatably connected to the screw conveyor. The mixing disk can therefore be loosely co-rotated by the screw conveyor, but is not rotationally connected to the screw conveyor.

The feed material and the at least one additional medium are pressed and kneaded through the holes and/or recesses of the mixing disk, which results in good mixing of the feed material with the additional medium.

In order to achieve a uniform enrichment of the feed material with the supplied medium, it is advantageous if at least one additional medium can be supplied to the material conveying device as a function of at least one conveying parameter.

In one embodiment variant of the invention, it is provided that at least one conveying parameter is an actual volumetric flow rate or mass flow rate of the feed material emerging from the outlet. The volumetric flow rate or mass flow rate can be determined, for example, at the outlet by a suitable volumetric flow or mass flow measuring device. Alternatively or additionally, it is possible to determine the volume flow rate or mass flow rate from the speed of the screw conveyor.

It is also possible for at least one conveying parameter to be formed by the speed of the screw conveyor and for at least one additional medium to be fed to the material conveying device as a function of at least one conveying parameter. A conventional speed sensor can be used to determine the speed.

Alternatively or additionally, it can be provided that at least one conveying parameter is a current consumption of the drive device of the screw conveyor formed by an electric motor, wherein preferably the current consumption can be determined by an evaluation device.

One embodiment variant of the invention provides that the screw conveyor can be driven by a first drive device and the feed hopper can be driven by a second drive device, with at least one drive device preferably being formed by a speed-controllable electric motor.

Preferably, the material conveying device has at least one electronic control unit, which is designed to control the supply of the additional medium as a function of the at least one conveying parameter.

In order to solve the problem set, a method is provided according to the invention which provides that an additional medium is fed to the non-free-flowing or viscous feed material in the area of the screw conveyor—preferably between the hopper outlet and the end of the screw conveyor facing the outlet.

Ideally, the feed material and the additional medium are mixed, preferably in the screw shaft.

In order to achieve a uniform admixture, it is provided in one embodiment variant of the invention that the additional medium is supplied to the material conveying device as a function of at least one conveying parameter.

According to one embodiment variant, a quantity or a weight of the currently conveyed feed material is selected as at least one conveying parameter, wherein preferably the quantity or the weight of the feed material is defined by a dosing volume or shot weight of an injection mold of the injection-molding and/or extrusion unit.

Alternatively or additionally, it may be provided that a volumetric flow rate or mass flow rate of the feed material exiting the material conveying device is selected as at least one conveying parameter, with the volumetric flow rate or mass flow rate of the feed material being measured particularly preferably at the outlet from the material conveying device.

A further embodiment variant of the invention provides that the speed of the screw conveyor is selected as at least one conveying parameter, preferably the speed of the screw conveyor is measured.

Furthermore, alternatively or additionally, it may be provided that an input current of the drive device of the screw conveyor is selected as at least one conveying parameter, with the input current preferably being detected by an evaluation device.

It is further provided within the scope of the invention that the screw conveyor is operated as a dynamic mixer with an adjustable follow-up time once a desired dosing quantity has been reached. This can improve the thorough mixing of the feed material with the additional medium.

The invention is explained in more detail below with reference to the non-limiting exemplary embodiments shown in the figures, which show schematically:

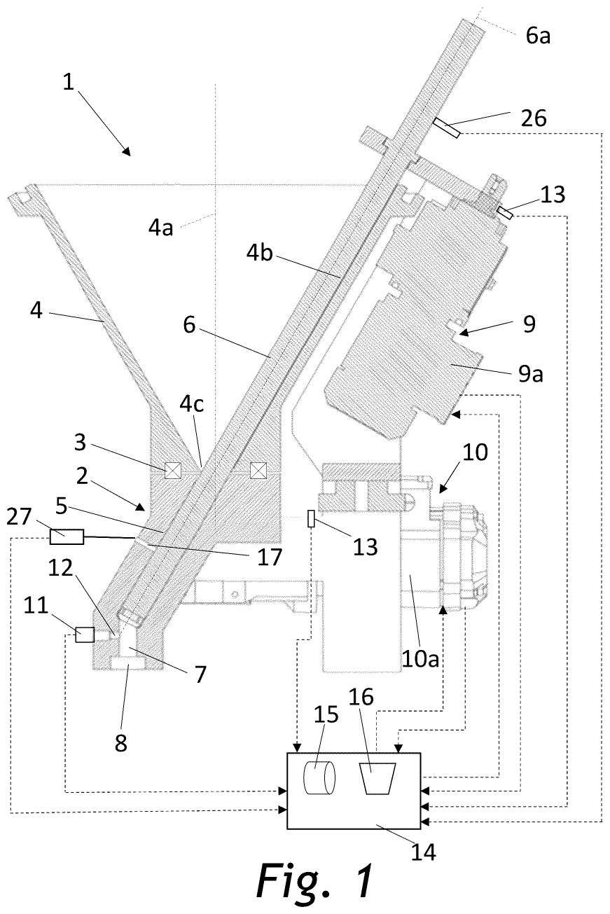

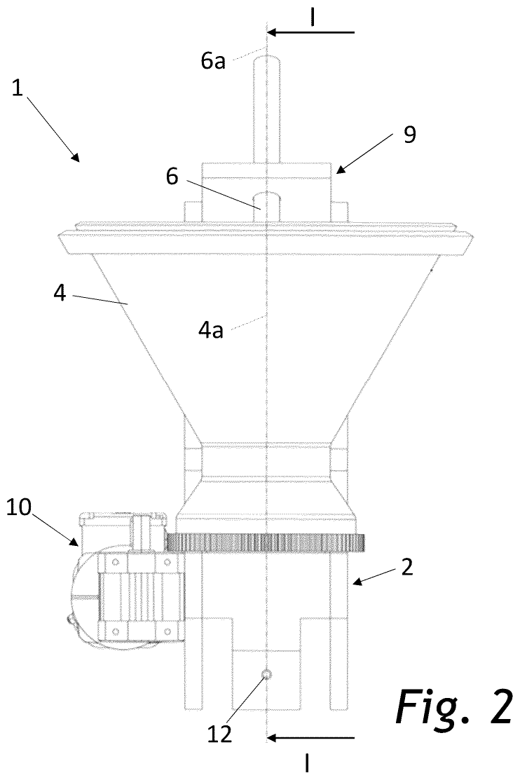

FIG. 1 shows a material conveying device according to the invention in an embodiment variant in a longitudinal section according to line I-I in FIG. 2;

FIG. 2 shows a side view of the material conveying device;

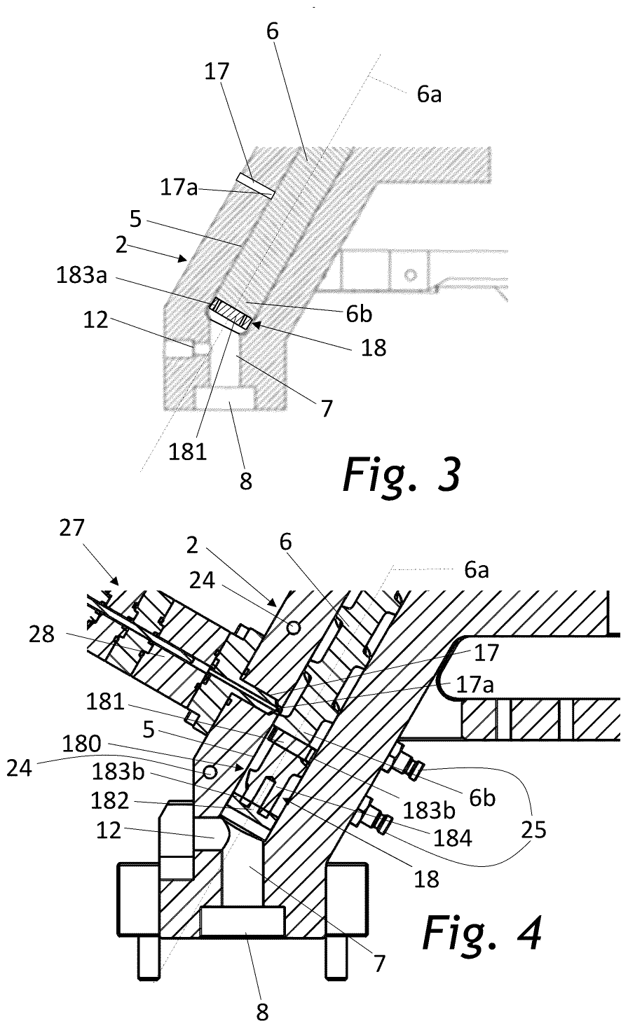

FIG. 3 shows a detail of this material conveying device; and

FIG. 4 shows a detail of the material conveying device in a further embodiment.

FIG. 1 and FIG. 2 show a material conveying device 1 according to the invention for the controlled feeding of a non-free-flowing or viscous, in particular plasticizable material, for example HTV (solid silicone), polyester PMC, rubber and other “doughy” materials, to an injection-molding and/or extrusion unit.

The material conveying device 1 has a stationary bracket 2 on which a feed hopper 4 is rotatably mounted about an axis of rotation 4a via at least one pivot bearing indicated by reference sign 3. A screw conveyor 6 is arranged in a screw shaft 5 of the bracket 2 along an inner jacket surface 4b of the feed hopper 4 so that it can rotate about an axis of rotation 6a, wherein the screw shaft 5 is connected to a hopper outlet 4c of the feed hopper 4. The screw conveyor 6 is designed to convey the non-free-flowing or viscous material from the feed hopper 4 via an outlet channel 7 to an outlet 8 of the console 2. In the exemplary embodiment shown, the screw conveyor 6 is driven by a first drive device 9 and the feed hopper 4 is driven by a second drive device 10. The drive devices 9, 10 are formed by, for example, variable-speed electric motors.

In the area of the outlet 8 in the example shown in FIG. 1, a pressure transducer 11 is arranged in a bore 12 connected to the outlet channel 7.

Reference sign 13 indicates a torque transducer arranged in the drive path of the screw conveyor 6 and/or in the drive path of the feed hopper 4.

The material conveying device 1 has an electronic control unit 14, which is designed to control the supply of at least one additional medium through at least one medium supply channel 17 as a function of at least one conveying parameter, as will be explained below.

In addition, the electronic control unit 14 can be designed to control at least one drive device 9, 10 and/or at least one shaft coupling—not shown further in FIG. 1 and FIG. 2—in the drive train between drive device 9 and screw conveyor 6 and/or between drive device 10 and feed hopper 4. Depending on the design, the electronic control unit 14 is connected to at least one drive device 9, 10 and/or shaft coupling and/or a pressure sensor 11 and/or a torque sensor 13. For example, a memory device 15 for storing a defined limit value of the operating parameter and a comparison and evaluation device 16 for comparing a current operating parameter with the defined limit value of the operating parameter are integrated into the electronic control unit 14. The electronic control unit 14 is designed to reduce or interrupt the drive of the feed hopper 4 if the defined limit value of the operating parameter is reached or exceeded. At least one operating parameter can be formed by the drive torque of the screw conveyor 6 or the feed hopper 4, the conveying pressure of the material conveying device 1 or the current consumption of at least one drive device 9, 10 formed by an electric motor—for example the first drive device 9 for the screw conveyor 6.

FIG. 3 shows a detail of the material conveying device 1 from FIG. 1.

As can be seen in particular from FIG. 3, the bracket 2 has at least one media feed channel 17 opening into the screw shaft 5. The mouth 17a of the media feed channel 17 into the screw shaft 5 is advantageously arranged between the hopper outlet 4c of the feed hopper 4 and the end 6b of the screw conveyor 6, which faces the outlet channel 7 or the outlet 8.

At least one liquid, doughy or free-flowing medium, for example at least one cross-linking agent, at least one silicone oil and/or at least one coloring material—in particular at least a color paste—can be actively fed to the non-free-flowing or viscous feed material via the media feed channel 17. In order to achieve good mixing of the medium with the non-free-flowing or viscous feed material, at least one mixing device 18 is arranged in the region of the screw conveyor 6 and/or downstream of the screw conveyor 6, wherein the mixing device 18 is preferably arranged in the screw shaft 5—for example in the region of the end 6b of the screw conveyor 6. The mixing device 18 has, for example, a mixing disk 181 with a plurality of axial holes 183a. In order to improve mixing, a plurality of mixing disks 181, 182 can also be arranged one behind the other in the conveying direction. At least one mixing disk 181 can be connected to the screw conveyor 6 in a rotationally fixed and rigid manner or attached to the screw conveyor 6 in a floating manner. Instead of axial bores 183a or in addition to these, recesses 183b with different geometries can be arranged on the circumference of the mixing disk 181 (see FIG. 4).

FIG. 4 also shows a console 2 of a material conveying device 1 in a further embodiment variant according to the invention in a sectional view analogous to FIG. 3, wherein the console 2 also has a media feed channel 17 opening into the screw shaft 5, wherein the mouth 17a of the media feed channel 17 is arranged between the hopper outlet 4c of the feed hopper 4 and the end 6b of the screw conveyor 6, which faces the outlet channel 7 or the outlet 8. In FIG. 4, the mixing device 18 is designed as a mixing attachment 180 at the end 6b of the screw conveyor 6, which is non-rotatably connected to the screw conveyor 6. The mixing attachment 180 has a first mixing disk 181 and a second mixing disk 182 with recesses 183b on the circumference of the respective mixing disks 181, 182, with a screw-shaped mixing element 184 being arranged between the mixing disks 181, 182.

It is possible to operate the screw conveyor 6 as a dynamic mixer with an adjustable follow-up time once a desired dispensing quantity has been reached, in order to improve the thorough mixing of the feed material with the paint material.

Conveniently, the media can be fed through the at least one media feed channel 17 as a function of at least one conveying parameter of the material conveying device 1, for example as a function of the speed of the screw conveyor 6 and/or the feed hopper 4 and/or the current consumption of the drive device 9, 10 of the screw conveyor 6 or the feed hopper 4. The speed of the screw conveyor 6 is measured, for example, via a speed sensor 26 and fed to the control unit 14, which uses it to determine a current volume flow or mass flow. Depending on the determined volume flow or mass flow of the material to be conveyed, the additional medium is supplied by controlling a dosing device 27, for example a screw feed pump or a plunger pump 28 (see FIG. 4), for the additional medium accordingly by the control unit 14. In the case of a screw feed pump, its speed is controlled accordingly by the control unit 14. In the case of a plunger pump 28, its stroke defines the amount of additional medium supplied; the control unit 14 thus controls the number of plunger strokes of the plunger pump 28. The feed parameter can be different or the same as the operating parameter of the material feed device 1 used to operate the feed hopper 4. In the case of an application on an extruder or with an injection molding unit, the media feed can take place depending on the dosing volume or the shot weight in the injection molding tool.

The advantage of feeding a color material separately from the feed material, for example, is that a uniform, transparent, neutral material can be used as the feed material. It is therefore no longer necessary to store a colored feed material for each color used, which can significantly reduce the storage capacity for the feed material.

Cooling holes 24 for a cooling medium can be provided in the bracket 2 to control the temperature of the screw shaft 5 and the screw conveyor 6 (FIG. 4). Reference signs 25 indicate connections for supply and discharge lines for supplying and discharging the cooling medium, which are not shown further.

1. A material conveying device for feeding an injection molding or extrusion unit with a non-free-flowing or viscous feed material, wherein the material conveying device includes a feed hopper rotatable relative to a bracket about an axis of rotation and a screw conveyor arranged rotatably along an inner jacket surface of the feed hopper in a screw shaft of the bracket, which is configured to convey the feed material from the feed hopper to an outlet, wherein the screw shaft is connected to a hopper outlet of the feed hopper, and wherein the screw conveyor drivable via at least one drive device, wherein at least one media feed channel opens into the screw shaft, which at least one media feed channel is designed to feed at least one additional medium to the feed material, wherein at least one mixing device is arranged in the region of the screw conveyor, which at least one mixing device is designed to mix the feed material and the additional medium.

2. The material conveying device according to claim 1, wherein the mouth of the media feed channel into the screw shaft is arranged between the hopper outlet and an end of the screw conveyor facing the outlet.

3. The material conveying device of claim 1, wherein the mixing device is arranged in the screw shaft.

4. The material conveying device of claim 1, wherein the mixing device comprises at least one, in particular circular, mixing disk, wherein the mixing disk has at least one recess on the circumference.

5. The material conveying device according to claim 1, wherein the mixing device has at least two axially spaced-apart mixing disks, wherein a screw-shaped mixing element (184) is arranged between the two mixing disks.

6. The material conveying device of claim 1, wherein at least one mixing disk of the mixing device (18) is non-rotatably connected to the screw conveyor.

7. The material conveying device of claim 1, wherein at least one mixing disk of the mixing device is floatingly connected to the screw conveyor.

8. The material conveying device of claim 1, wherein the additional medium can be supplied to the material conveying device as a function of at least one conveying parameter.

9. The material conveying device of claim 8, wherein at least one conveying parameter is selected from the group consisting of a quantity or a weight of the currently conveyed feed material, wherein the quantity or the weight of the currently conveyed feed material is defined by a dosing volume or shot weight of an injection mold of the injection-molding or extrusion unit,
an actual volumetric flow rate or mass flow rate of the feed material emerging from the outlet,
a current speed of the screw conveyor, wherein the current speed can be determined by at least one rotational speed sensor arranged in the drive path of the screw conveyor, and
an actual current consumption of the drive device of the screw conveyor or of the feed hopper comprising at least one electric motor, wherein preferably the current consumption can be determined by a comparison and evaluation device.

10. The material conveying device of claim 1, wherein the material conveying device has at least one electronic control unit which is designed to control the supply of the additional medium as a function of the at least one conveying parameter.

11. A method for feeding at least one injection molding or extrusion unit with a non-free-flowing or viscous material, having a material conveying device with a rotatable feed hopper and a screw conveyor arranged rotatably along an inner jacket surface of the feed hopper, wherein the screw conveyor driven via at least one drive device, according to one of claim 1, wherein an additional medium is fed to the non-free-flowing or viscous feed material in the region of the screw conveyor between the hopper outlet and the end of the screw conveyor facing the outlet.

12. The method according to claim 11, wherein the feed material and the additional medium are mixed, preferably in the screw shaft.

13. The method according to claim 11, wherein the additional medium is supplied to the material conveying device as a function of at least one conveying parameter.

14. The method according to claim 13, wherein at least one of
a quantity or a weight of the feed material is selected as a conveying parameter, wherein the quantity or the weight of the feed material is defined by a dosing volume or shot weight of an injection mold of the injection-molding or extrusion unit,
a volumetric flow rate or a mass flow rate of the feed material emerging from the material conveying device is selected as a conveying parameter, wherein the volumetric flow rate or the mass flow rate of the feed material is measured at the outlet from the material conveying device,
the speed of the screw conveyor is selected as a conveying parameter, wherein the speed of the screw conveyor is measured, and
an input current of the drive device of the screw conveyor is selected as a conveying parameter, wherein the input current is detected by a comparison and evaluation device.

15. The method according to claim 11, wherein the screw conveyor is operated as a dynamic mixer with an adjustable follow-up time after reaching a desired dosing quantity.

16. The material conveying device of claim 1, wherein the feed hopper is drivable via the at least one drive device.

17. The material conveying device of claim 1, wherein the at least one mixing device is arranged downstream of the screw conveyor.
